(19) United States
(12) Patent Application Publication
(10) Pub. No.: US 2021/0118038 A1
(43) Pub. Date: Apr. 22, 2021

(54) SELF-SERVICE KIOSK FOR DETERMINING GLOVE SIZE

(71) Applicant: THE HILLMAN GROUP, INC., Cincinnati, OH (US)

(72) Inventors: Michael J. SCHMIDT, Gilbert, AZ (US); Jordan Daniel SHOENHAIR, Scottsdale, AZ (US); Brian David ROSNER, Phoenix, AZ (US); Byron Keith GRICE, Phoenix, AZ (US); Michael ROSENBLATT, Boulder, CO (US); Wendell Makoto LUCKOW, Longmont, CO (US)

(73) Assignee: THE HILLMAN GROUP, INC., Cincinnati, OH (US)

(21) Appl. No.: 17/076,284

(22) Filed: Oct. 21, 2020

Related U.S. Application Data
(60) Provisional application No. 62/924,478, filed on Oct. 22, 2019.

(51) Int. Cl. G06Q 30/06; G06T 11/00; G06T 7/60; G06T 7/13

(52) U.S. Cl. CPC G06Q 30/0631; G06T 11/00; G06T 7/60; G06T 2207/30196; G06T 2207/20081; G06T 2200/24; G06T 7/13

(57) ABSTRACT

A self-service kiosk for determining glove size is disclosed. The kiosk may have a platform for placement of a user's hand. The kiosk may also have an imaging device that acquires a digital image of the hand. Further, the kiosk may have a memory, and a processor that executes instructions stored in the memory. The processor may determine a size characteristic of the hand based on the digital image or the scan. The processor may compare the size characteristic with one or more product characteristics stored in a data structure and associated with one or more products. Further, the processor may select a product, having a product characteristic matching the size characteristic. The kiosk may also have a display for displaying information associated with the at least one product selected by the processor.

### CROSS-REFERENCE TO RELATED APPLICATION

This application is based on and claims benefit of priority of U.S. Provisional Patent Application No. 62/924,478, filed Oct. 22, 2019, which is incorporated herein by reference.

### TECHNICAL FIELD

The present disclosure relates generally to a self-service kiosk and more particularly to a self-service kiosk for determining glove size.

### BACKGROUND

Selecting the correct size of a glove can often be challenging. Glove sizes are typically labeled as small, medium, large, etc., by the manufacturers of the gloves. A customer, however, usually does not have information that indicates whether the customer's hand corresponds to, for example, a small, a medium, or a larger size glove. In a typical scenario, a customer approaches a shelf or rack of gloves in a retail location and must try on different gloves to determine a best fitting glove. Furthermore, there may be variations in the labeled glove sizes. For example, gloves labeled small by different manufacturers may still correspond to different sizes. Similarly, for example, the same labeled size “large” may represent different sizes of gloves for men and women. Thus, the only recourse for a customer to find the right glove size is to try on a variety of gloves from different manufacturers.

One way to simplify the process of determining the glove size may include, for example, consulting a store associate. The store associate may identify the correct glove size based on that person's experience in selling gloves. However, the need to find, approach, and consult a store associate may be burdensome and may make the purchasing process inconvenient. Furthermore, depending on the skill of the store associate, the size recommended by that associate may still not provide a best fit glove for the customer. Another potential option may be to have the customer measure the size of their hand using a physical tape measure or ruler and then look at a sizing chart to determine the best fit glove size. However, this requires making measuring devices like tape measures or rulers available and positioned in the retail location adjacent to where the gloves may be displayed for sale. Furthermore, reading the size charts may be cumbersome and/or prone to errors, which in turn may result in the customer having to try on incorrectly sized gloves. This may again inconvenience the customer and may discourage the customer from completing a purchase. Therefore, there exists a need to provide easy to use, low cost, and efficient tools and methods to allow everyday users to quickly and accurately determine a best fit glove size regardless of the type of glove or the manufacturer of the glove.

The self-service kiosk of the present disclosure solves one or more of the problems set forth above and/or other problems of the prior art.

### SUMMARY

In one aspect, the present disclosure is directed to a self-service kiosk. The kiosk may include a platform configured for placement of a user's hand. The kiosk may also include an imaging device configured to acquire at least one of a digital image or a scan of the hand. Further, the kiosk may include at least one memory and at least one processor configured to execute instructions stored in the at least one memory. The processor may be configured to determine at least one size characteristic of the hand based on the digital image or the scan. The processor may also be configured to compare the at least one size characteristic with one or more product characteristics stored in a data structure. The one or more product characteristics may be associated with one or more products. Further, the processor may be configured to select at least one product from the one or more products. The at least one product may include at least one product characteristic matching the at least one size characteristic. The kiosk may include a display configured to display information associated with the at least one product selected by the at least one processor.

In yet another aspect, the present disclosure is directed to a self-service kiosk for determining glove size. The kiosk may include a platform configured for placement of a user's hand. The kiosk may also include a camera configured to acquire a digital image of the hand. Further, the kiosk may include at least one memory and at least one processor configured to execute instructions stored in the at least one memory. The processor may be configured to determine a palm width and a finger length of the hand based on the digital image. The processor may also be configured to receive, from a data structure, information including a plurality of glove palm widths and glove finger lengths corresponding to a plurality of gloves. The processor may be configured to compare the palm width and the finger length of the hand with the information received from the data structure. The processor may also be configured to select at least one glove from the plurality of gloves. The at least one glove may have at least one of a glove palm width or a glove finger length that may match a respective one of the palm width or the finger length of the hand. The processor may be configured to determine a size of the at least one glove based on the information received from the data structure. The kiosk may include a display configured to display the determined size of the at least one glove

### BRIEF DESCRIPTION OF THE DRAWINGS

FIG. 1 is an illustration of an exemplary disclosed self-service kiosk for determining glove size installed in a retail location;

FIG. 2 is another illustration of the exemplary disclosed self-service kiosk of FIG. 1;

FIG. 3 is an illustration of an exemplary disclosed system for hand size measurement and product sizing;

FIGS. 4A and 4B are exemplary illustrations of images of a user's hand obtained using the self-service kiosk of FIGS. 1 and 2; and

FIG. 5 is a flowchart illustrating an exemplary method of determining a glove size using the self-service kiosk of FIGS. 1 and 2.

### DETAILED DESCRIPTION

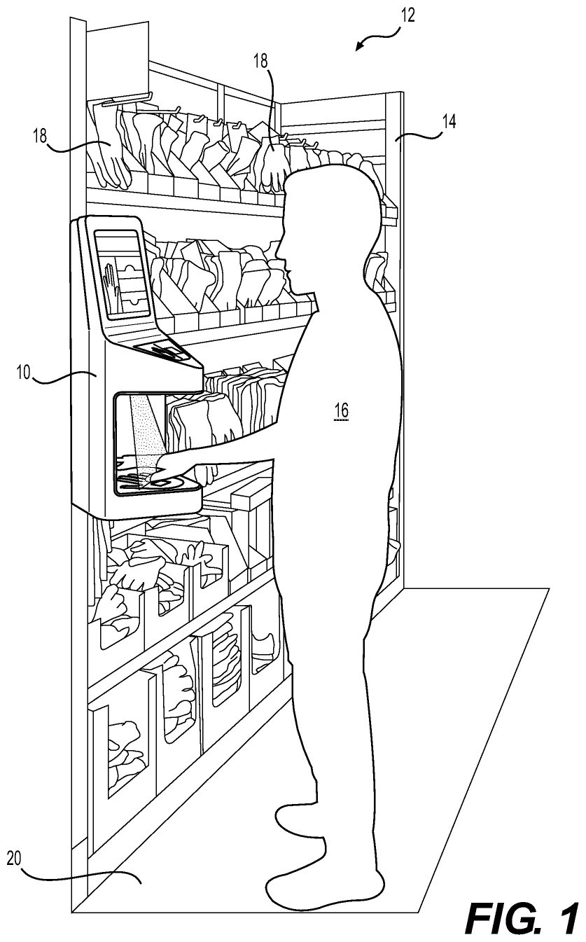

FIG. 1 illustrates an exemplary self-service kiosk 10 located in a commercial or retail location 12, having storage 14 for displaying a variety of products 18 for purchase by user 16. Kiosk 10 may be a small structure attached to or located adjacent to storage 14. In one exemplary embodiment, kiosk 10 may have a width of about 8-12″, a depth of about 8-12″, and a height of about 12-24″. It is contemplated, however, that kiosk 10 may have dimensions different from those discussed above. Kiosk 10 may be a self-service kiosk configured to measure one or more dimensions associated with a user's hand and recommend one or more products having a size that may provide a best fit (e.g. a snug but comfortable fit) for the user's hand.

As illustrated in FIG. 1, storage 14 may be a shelf configured to display products for sale. It is contemplated, however, that storage 14 may take other forms, such as racks, hangers, or hooks attached to a vertical panel or wall of retail location 12. In one exemplary embodiment, storage 14 may be configured to store and display one or more gloves 18 and kiosk 10 may be configured to determine a best fit glove size for user 16 based on a measurement of the user's hand size. It is contemplated, however, that kiosk 10 may be located in other types of commercial or retail locations, for example, jewelry stores, watch sellers etc. It is also contemplated that kiosk 10 may be configured to determine a size of a user's finger or a user's wrist to allow user 16 to determine a best fit size of, for example, a ring, a bracelet, or a watch strap. In another exemplary embodiment, kiosk 10 may be configured to determine a shoe size for user 16. For example, kiosk 10 may be configured to determine a size of a foot of user 16 and recommend a best fit shoe size based on the determined size of the foot.

In one exemplary embodiment as illustrated in FIG. 1, kiosk 10 may be attached to shelf 14 and positioned at a predetermined height above a floor 20 of retail location 12 to allow user 16 to conveniently interact with kiosk 10. It is contemplated, however, that in some exemplary embodiments, kiosk 10 may be a stand-alone kiosk placed adjacent to shelf 14. It is further contemplated that kiosk 10 may be compliant with the provisions of the Americans With Disabilities Act (ADA) and may include features that may allow a height and/or orientation of kiosk 10 to be adjusted for the convenience of user 16. In one exemplary embodiment as illustrated in FIG. 1, kiosk 10 may have a generally diamond-type shape, which may allow user 16 easy access to products 18 located in storage 14. It is contemplated, however, that kiosk 10 may have other shapes, for example semi-circular, oval, square, rectangular, triangular, etc.

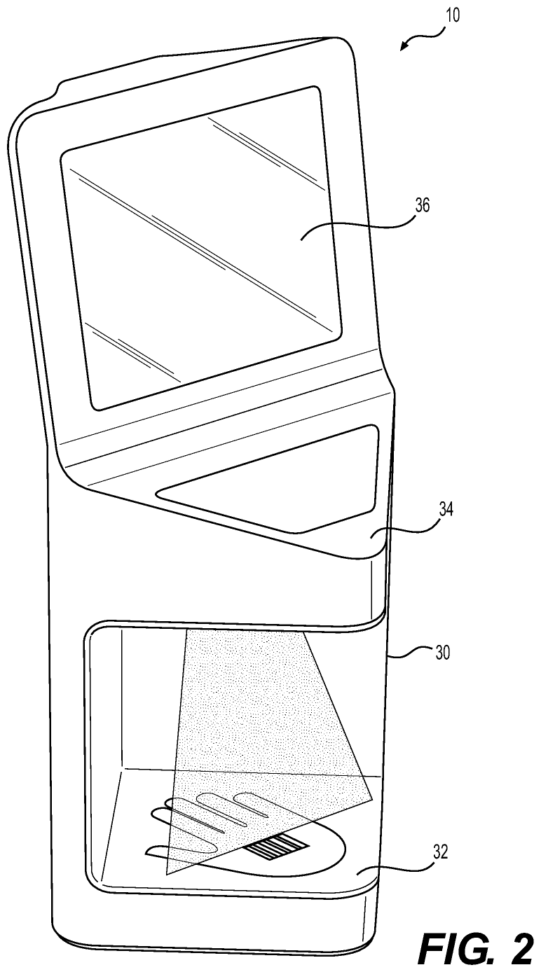

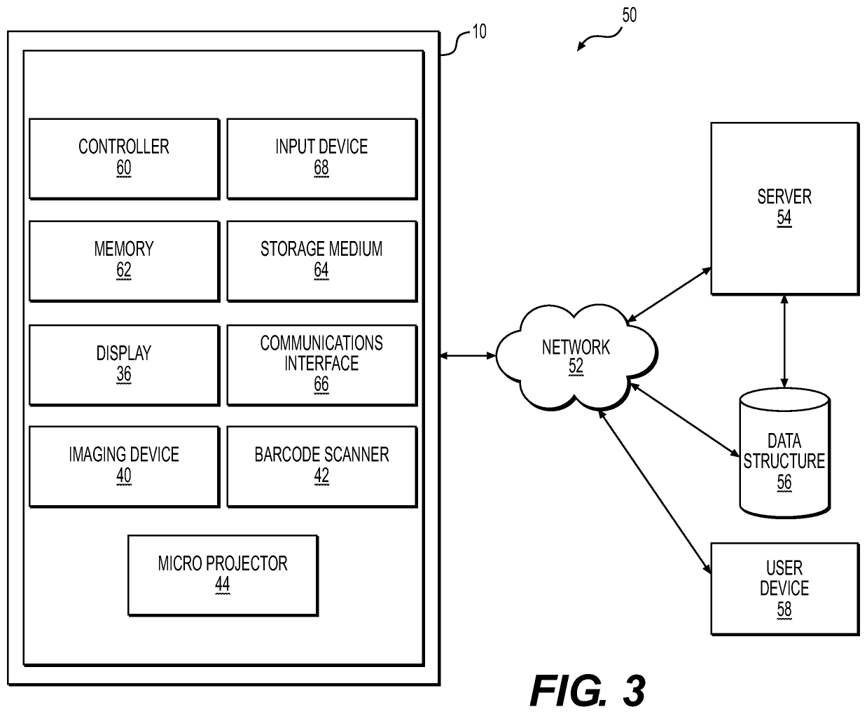

FIG. 2 illustrates an enlarged view of kiosk 10. Kiosk 10 may include housing 30, platform 32, platform 34, display 36, imaging device 40 (see FIG. 3), barcode scanner 42 (see FIG. 3), and micro projector 44 (see FIG. 3). Housing 30 may be a hard-shell enclosure that may enclose one or more components of kiosk 10. In one exemplary embodiment, housing 30 may be attached to a vertical post or to shelf 14. In other exemplary embodiments, housing 30 may be placed flat on a table or other surface (e.g. floor 20). Platform 32 may be attached to housing 30 and may extend outward from housing 30. Platform 32 may form a base of housing 30, although in some exemplary embodiments, platform 32 may be spaced apart from the base of kiosk 10. Platform 32 may be configured to provide a generally flat surface on which user 16 may place a hand for measurement of hand size. Platform 32 may have a shape and size configured to accommodate user 16's hand.

Like platform 32, platform 34 may be attached to housing 30 and may extend outward from housing 30. Platform 34 may be positioned vertically spaced apart from platform 34. In one exemplary embodiment, platform 34 may have a shape and size similar to that of platform 32. It is contemplated, however, that platforms 32 and 34 may have similar or different shapes and sizes. Platform 34 may be configured to support one or more of imaging device 40, barcode scanner 42, and/or micro projector 44, which may be mounted to an underside of platform 34 and, therefore, are not visible in FIG. 2. It is contemplated, however, that in some exemplary embodiments, kiosk 10 may not include platform 32. In these exemplary embodiments, an object (e.g. user 16's hand) may be placed under a downward-facing imaging device 40 to allow imaging device 40 to obtain a digital image or a scan of the object. Although imaging device 40 has been disclosed as being mounted to an underside of platform 34, it is contemplated that kiosk 10 may include one or more additional imaging devices mounted in other locations on housing 30 to image a side of a user's hand, for example, to determine a thickness of the user's hand.

Display 36 may be positioned adjacent platform 34. In one exemplary embodiment as illustrated in FIG. 2, display 36 may project vertically in a direction away from platform 34 such that platform 34 may be positioned between display 36 and platform 32. It is contemplated, however, that display 36 may be attached to any surface of kiosk 10 or may be spaced apart from kiosk 10. Display 36 may be configured to display data, instructions, and/or information to user 16. Display 36 may be a cathode ray tube (CRT) monitor, a liquid crystal display (LCD), a light emitting diode (LED) display, a projector, a projection television set, a touchscreen display, or any other kind of display device known in the art. Display 36 may be configured to display one or more graphical user interfaces capable of displaying information and receiving inputs, for example, via a touchscreen or another input device. For example display 36 may be configured to display a graphical keyboard or numeric keypad to allow user 16 to enter data and/or information. Display 36 may also be configured to display information regarding a hand size of user 16 and/or information regarding a size of a product (e.g. glove, ring, etc.) suitable for user 16.

Imaging device 40 may be configured to obtain a digital image or a scan of an object placed on platform 32. When imaging device 40 detects the presence of a hand of user 16 on platform 32, imaging device 40 may obtain the digital image or scan of the hand of user 16. Imaging device 40 may include a two-dimensional (2D) or three-dimensional (3D) camera configured to obtain the digital image. In some exemplary embodiments, imaging device 40 may include one or more CCD array cameras, digital cameras, 2D or 3D scanners, or other types of image capture devices. In other exemplary embodiments, imaging device 40 may include a 2D or 3D scanner configured to obtain a scan of the object placed on platform 32, for example, using laser-scanning techniques.

Barcode scanner 42 may be an optical scanner or reader configured to scan or read printed barcodes, for example, on tags attached to the one or more products 18 stored in storage 14. Barcode scanner 42 may be configured to read both linear or one-dimensional (1D) barcodes, 2D barcodes, and/or Quick Response (QR) codes. Barcode scanner 42 may allow user 16 to present a product 18 with a tag containing a barcode, read the barcode, and cause display 36 to display information associated with the product.

Micro projector 44 may be configured to project a grid pattern or pattern of dots on an object placed on platform 32. Imaging device 40 may be configured to capture an image of the object (e.g. hand of user 16) placed on platform 32 superimposed with the dot pattern projected by micro projector 44. It is contemplated that the dot pattern in the image may be distorted due to the shape and curvature of the object. Kiosk 10 may be configured to determine one or more dimensions associated with the object by detecting the distortions in the pattern of dots in the image. Although imaging device 40, barcode scanner 42 and micro projector 44 have been illustrated in FIG. 3 as separate components, it is contemplated that in some exemplary embodiments, they may all be integrated into a single component. For example, imaging device 40 may be configured to perform the functions of a camera, a barcode reader, and/or a micro projector.

FIG. 3 illustrates a schematic of an exemplary system 50 for hand size measurement and product sizing. System 50 may include kiosk 10, network 52, server 54, data structure 56, and/or user device 58. System 50 may be configured to determine one or more dimensions of a hand placed by user 16 on platform 32 of kiosk 10. System 50 may also be configured to identify products 18 (e.g. gloves, rings, bracelets, wrist straps, etc.) based on the determined dimensions, such that the identified products may provide a snug but comfortable fit (e.g. best fit) to user 16. Kiosk 10 may include several components, for example, controller 60, memory 62, storage medium 64, and/or communications interface 66 that may be enclosed by housing 30. In some exemplary embodiments, kiosk 10 may include input device 68, which may be disposed on housing 30, for example, on or adjacent to platform 34.

Controller 60 may be configured to control the operation one or more components of kiosk 10, including, for example, display 36, imaging device 40, barcode scanner 42, micro projector 44, memory 62, storage medium 64, communications interface 66, and/or input device 68. Controller 60 may embody any number of microprocessors, digital signal processors (DSPs), etc. Various other known circuits may be associated with controller 60, including power supply circuitry, signal-conditioning circuitry, and communication circuitry.

Memory 62 may embody non-transitory computer-readable media, for example, Random Access Memory (RAM) devices, NOR or NAND flash memory devices, and Read Only Memory (ROM) devices. Storage medium 64 may embody non-transitory computer-readable media, such as, RAM, NOR, NAND, or ROM devices, hard drives, solid state drives, tape drives, RAID arrays, compact discs (CDs), digital video discs (DVDs), Blu-ray discs (BD), etc. Memory 62 and/or storage medium 64 may be configured to store data or instructions executable by controller 60.

Communications interface 66 may allow software and/or data to be transferred between kiosk 10, network 52, server 54, data structure 56, user device 58, and/or other components. For example, communications interface 66 may allow data, instructions, and/or firmware associated with controller 60 of kiosk 10 to be updated by transferring the data, instructions, and/or firmware from, for example, server 54. Communications interface 66 may include a modem, a network interface (e.g., an Ethernet card or a wireless network card), a communications port, a PCMCIA slot and card, a cellular network card, etc. Communications interface 66 may transfer software and/or data in the form of signals, which may be electronic, electromagnetic, optical, or other types of signals capable of being transmitted and received by communications interface 66. Communications interface 66 may transmit or receive these signals using wire, cable, fiber optics, radio frequency (“RF”) link, and/or other communications channels. Communications interface 66 may be configured to communicate via WI-FI, BLUETOOTH, nearfield, LI-FI, and/or any other wireless transmission methods.

Input device 68 may be configured to receive inputs from one or more users 16 of system 50. In one exemplary embodiment, input device 68 may enable user 16 to make selections of one or more portions of text and or graphical images displayed on display 36. Input device 68 may also enable user 16 to provide numerical, textual, graphic, or audio-visual inputs to controller 60. Input device 68 may include a physical keyboard, gesture recognition interface, mouse, joystick, stylus, etc. Input device 68 may also include one or more microphones or other audio devices using, for example, speech-to-text and/or voice recognition applications.

Network 52 may facilitate electronic communication and exchange of data and/or information between kiosk 10, server 54, data structure 56, and/or user device 58. Network 52 may include any combination of communication networks, for example, the Internet and/or another type of wide area network, an intranet, a metropolitan area network, a local area network, a wireless network, a cellular communications network, etc.

Server 54 may include one or more computational devices that may be used individually or in cooperation with one or more of kiosk 10, data structure 56, and/or user device 58, to determine the one or more dimensions of a hand of user 16, and/or to identify and select one or more products 18 based on the determined dimensions. Server 54 may be a general-purpose computer, a mainframe computer, or any combination of these components. In certain embodiments, server 54 may be standalone, or it may be part of a subsystem, which may be part of a larger system. For example, server 54 may represent distributed servers that are remotely located and communicate over a network (e.g., network 52) or over a dedicated network, such as a local area network (LAN). In addition, consistent with the disclosed embodiments, server 54 may be implemented as a server, a server system comprising a plurality of servers, or a server farm comprising a load balancing system and a plurality of servers. Server 54 may also include display, controller, memory, storage medium, communications interface, and/or input device that may have a structure and function similar to display 36, controller 60, memory 62, storage medium 64, communications interface 66, and/or input device 68, respectively.

Data structure 56 may be configured to store information regarding one or more products 18. For example, data structure 56 may be configured to store one or more dimensions associated with one or more products 18. Data structure 56 may additionally or alternatively store information regarding other characteristics (e.g. manufacturer name, brand, logo, color, shape, texture, price, availability in retail location 12 etc.) of the one or more products. Controller 60 and/or server 54 may directly or indirectly access data structure 56 to retrieve information from or store information into data structure 56. A data structure consistent with the present disclosure may include any collection of data values and relationships among them. By way of non-limiting examples, data structures may include an array, an associative array, a linked list, a binary tree, a hash table, a record, a tagged union, etc. By way of additional example, a data structure may include an XML data structure, an RDBMS data structure, an SQL data structure, etc. Although data structure 56 is illustrated in FIG. 3 as being separated from kiosk 10 and/or server 54, it is contemplated that in some exemplary embodiments, data structure 56 may be part of kiosk 10 and/or server 54 and may be stored in memory 62 or storage medium 64 associated with kiosk 10 and/or server 54. It is also contemplated that in some exemplary embodiments, server 54 and/or data structure 56 may be part of kiosk 10 and network 52 may be used by kiosk 10, for example, for reporting purposes, error tracking, data collection, sending updates, remote technical support/monitoring machine health, and/or to allow user 16 to order gloves 18 online.

User device 58 may include one or more computational devices associated with a user. By way of example, user device 58 may include computational devices such as personal computers, laptop computers, desktop computers, tablet computers, notebooks, mobile phones, smart watches, other smart devices, etc. User device 58 may be configured to execute an application or a set of instructions to send or receive data and/or instructions from kiosk 10, server 54, and/or data structure 56. User device 58 may include a display, imaging device, barcode scanner, controller, memory, storage medium, communications interface, and/or input device that may have a structure and function similar to display 36, imaging device 40, barcode scanner 42, controller 60, memory 62, storage medium 64, communications interface 66, and/or input device 68, respectively.

It is contemplated that system 50 may include any number of kiosks 10, servers 54, data structures 56, and/or user devices 58. It is also contemplated that each of kiosk 10, server 54, and/or user device 58 may include any number of displays 36, imaging devices 40, barcode scanners 42, controllers 60, memories 62, storage media 64, communications interfaces 66, and/or input devices 68.

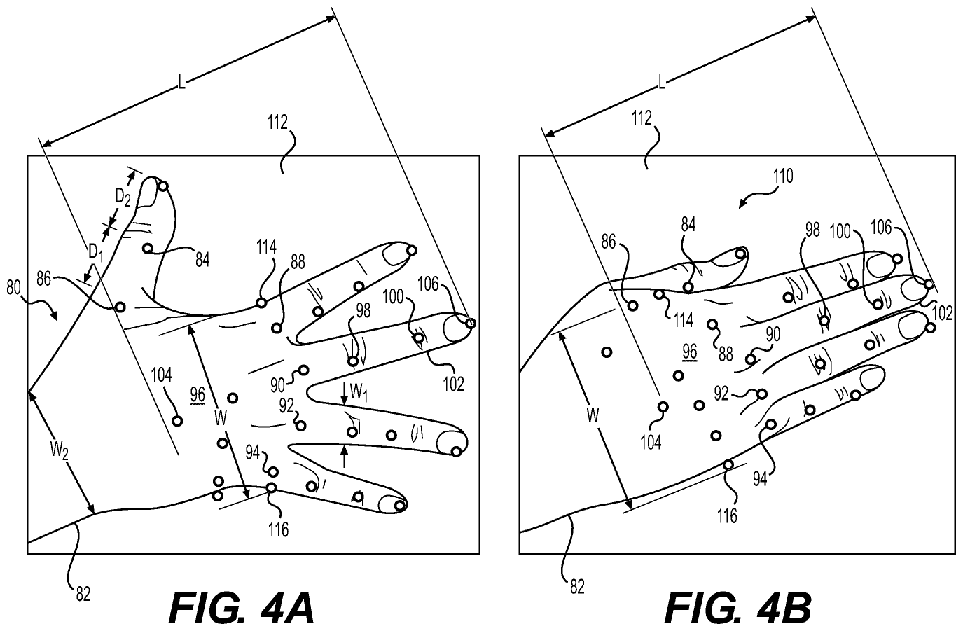

FIG. 4A illustrates an exemplary digital image and/or scan 80 of hand 82 of user 16. It is also contemplated that in some exemplary embodiments, imaging device 40 may obtain a series of images 80 in the form of a video stream. The following description refers to digital image 80 but is equally applicable to a 2D or 3D scan 80 of hand 82, and/or to one or more of the series of images 80. As illustrated in FIG. 4A, digital image 80 may be superimposed with one or more points (or dots) 84. In one exemplary embodiment, controller 60 and/or imaging device 40 of kiosk 10 may be configured to superimpose points 84 on digital image 80. In another exemplary embodiment, digital image 80 of hand 82 may be obtained using imaging device 40 associated with user device 58. It is contemplated that user device 58 may transmit digital image 80 to kiosk 10 and/or server 54 via a wired or wireless connection, for example, via network 52. It is further contemplated that controller 60 of user device 58, kiosk 10, and/or server 54 may be configured to superimpose points 84 on digital image 80. Points 84 may be visible on digital image 80. Alternatively, points 84 may not be visible on digital image 80, but rather may be represented by storing their respective positions in memory 62 and/or storage medium 64. As used in this disclosure, superimposing points 84 and/or using points 84 to determine one or more dimensions or size characteristics of hand 82 includes performing these operations even when points 84 are not visible.

In one exemplary embodiment, points 84 may coincide with predetermined locations on digital image 80. By way of example, points 86, 88, 90, 92, and 94 may be positioned adjacent locations where the thumb and fingers of hand 82 are attached to palm 96 of hand 82. Similarly, for example, points 98 and 100 may be located adjacent joints on middle finger 102 of hand 82, point 104 may be located generally at a center of palm 96, and point 106 may be located at a tip of middle finger 102. FIG. 4B illustrates another exemplary digital image 110 of hand 82 of user 16. A comparison of FIGS. 4A and 4B shows that the positions of the thumb and fingers in the two images 80 and 110 are different. FIGS. 4A and 4B also illustrate that the positions of points 84 on digital images 80 and 110 are automatically adjusted so that points 84 coincide with portions of digital images 80, 110 depicting hand 82 and not with background portion 112 of images 80 and 110. In one exemplary embodiment, controller 60 of kiosk 10, server 54, and/or user device 58 may execute a trained machine learning model configured to position dots 84-94, 100, 104, 106, etc. on portions of digital images 80, 110 depicting hand 82 instead of the background portions 112 regardless of the position and orientation of palm 96 or the fingers of hand 82.

For example, controller 60 may be provided with a training data set, including images of a plurality of hands 82 having a plurality of shapes, sizes, positions, and orientations. For each image, controller 60 may receive inputs from, for example, a user via input device 68 and/or touchscreen display 36. The received inputs may specify one or more size characteristics of hand 82 in each image. For example, the received inputs may specify the locations of points 86, 88, 90, 92, and 94 corresponding to locations where the thumb and fingers of hand 82 are attached to palm 96 of each hand 82. Likewise, for example, the received inputs may specify the locations of points 98, 100, 104, and 106 corresponding to the opposing edges and center of palm 96, and tip of middle finger 102 for each hand 82 in the training data set. Controller 60 may also receive inputs specifying scaling factors for each image and/or distances between points 84 in each image of the training data set. Alternatively, controller 60 may determine the distances based on the received inputs and scaling factors. In addition, controller 60 may receive inputs regarding whether hand 82 in each image of the training set may be classified as having a size that is, for example, small, medium, large, extra-large, etc. Controller 60 may be configured to train, for example, a neural network based machine learning model using the training data set and the inputs received from user 16. It is contemplated that in some exemplary embodiments, training of the machine learning model may be performed using an off-board controller 60 (e.g. a controller not associated with kiosk 10, controller 60 of server 54, etc.). In these embodiments, the trained machine learning model may be transmitted to kiosk 10 via, for example, network 52 or by directly installing the model on kiosk 10. Once the machine learning model has been trained, controller 60 may use the trained machine learning model to superimpose points 84 on images 80, 110 obtained by imaging device 40. It is contemplated that digital images 80, 110 may include images of hand 82 in any configuration. For example, user 16 may place a left or right hand, with palm facing up or down, etc. Controller 60 may be configured to superimpose points 84 (including, for example, points 86, 88, 90, 92, 94, 98, 100, 104, 106, etc.) on digital images 80, 110 regardless of the orientation and/or configuration of hand 82 of user 16.

Controller 60 may be configured to determine one or more size characteristics of hand 82. In one exemplary embodiment the one or more size characteristics may include one or more distances between pairs of points 84 located on hand 82. In some exemplary embodiments, the one or more size characteristics may include, for example, a palm width, a palm length, lengths of each of the fingers, length of the thumb, widths of each of the fingers, width of the thumb, width of the wrist, etc. It is contemplated that many other dimensions may be derived based on digital images 80, 110 of hand 82 and points 84. In some exemplary embodiments, controller 60 may be configured to determine a thickness of hand 82 based on an image of a side of hand 82 obtained, for example, using one or more additional imaging devices 40 mounted on housing 30 of kiosk 10. It is also contemplated that in some exemplary embodiments, controller 60 may be configured to provide instructions to user 16 via, for example, display 36 to rotate the wrist by about 90° while keeping hand 82 flat and extending the fingers to allow imaging device 40 mounted on platform 34 to image a side of hand 82.

For example, controller 60 may determine distances between adjacent pairs of points 84 or any pair of points 84. It is contemplated that controller 60 may employ a scaling factor to determine the distances using digital images 80, 110. For example, controller 60 may determine the scaling factor based on a representation of platform 32 in images 80 or 110 and known dimensions of platform 32. In other exemplary embodiments in which kiosk 10 does not include platform 32, controller 60 may determine the scaling factor based on one or more autofocus controls of imaging device 40 to determine a distance of hand 82 from imaging device 40. In other exemplary embodiments, digital images 80, 110 may include an object (e.g. a 25 cent coin, a ruler, etc.) having known dimensions, and controller 60 may determine the scaling factor based on the known dimensions of the object included in digital images 80, 110. It is contemplated that in some exemplary embodiments, controller 60 may be configured to determine the distances by, for example, counting the pixels between points 84 on digital images 80, 110 and scaling the number of pixels using the scaling factor. In some exemplary embodiments, controller 60 may also be configured to determine the distances and/or a size of hand 82 (e.g. small, medium, large, etc.) using the trained machine learning model. In other exemplary embodiments, the machine learning model may be trained to directly output a size of hand 82 without separately computing any distances or dimensions.

Controller 60 may be configured to compare the size characteristics (e.g. distances) determined from digital images 80, 110 with product characteristics associated with one or more products (e.g. gloves 18). Product characteristics for the one or more products 18 may be stored in data structure 56. Product characteristics may include, for example, distances between points corresponding to points 84, and/or information regarding color, texture, pricing, etc. for the product. It is also contemplated that for products like gloves 18, product characteristics may also include, for example, a glove palm width (e.g. width of glove portion corresponding to a user's palm), a glove palm length (e.g. length of glove portion corresponding to a user's palm), lengths of each of the fingers of glove 18, length of the thumb portion of glove 18, widths of each of the fingers of glove 18, width of the thumb portion of glove 18, width of the wrist portion of glove 18, etc. Controller 60 may be configured to select a product 18 from the plurality of products 18 based on a comparison of one or more size characteristics determined from digital images 80, 110 with product characteristics retrieved from data structure 56. For example, controller 60 may retrieve distances between adjacent pairs of points corresponding to points 84 for a plurality of gloves 18 from data structure 56. For each glove 18, controller 60 may determine differences in the distance between pairs of points obtained from image 80, 110, and corresponding pairs of points for glove 18. By way of example, consider distances “D1” and “D2” obtained by controller 60 using points 84 on image 80 or 110. Controller 60 may retrieve corresponding distances “D1a” and “D2a” for one or more gloves 18 from data structure 56. Controller 60 may determine differences, for example, D1-D1a, D2-D2a, etc. for the one or more gloves 18. Controller 60 may determine, for example, a maximum, minimum, or average difference for the one or more gloves 18. Controller 60 may then select glove 18 for which the maximum, minimum, or average difference is less than a corresponding predetermined threshold. In one exemplary embodiment, controller 60 may classify hand 82 as having, for example, one of a small, medium, large, extra large etc. size based on the size characteristics of hand 82 determined from images 80, 110 and/or using the trained machine learning model. Similarly, controller 60 may classify each glove 18 as having one of a small, medium, large, extra large etc. size based on the product characteristics of glove 18 and/or using the trained machine learning model. Alternatively, data structure 56 may store a size associated with each glove 18. Upon selecting glove 18 based on size characteristics for hand 82, controller 60 may display the size associated with selected glove 18 on display 36. Additionally or alternatively, controller 60 may display an image associated with selected glove 18 on display 36.

In another exemplary embodiment, controller 60 may generate a vector containing distances between pairs of points 84 in image 80 or 110. Controller may retrieve vectors containing corresponding distances for one or more gloves 18 from data structure 56. Controller 60 may then determine vector distances between the vector corresponding to image 80 or 110 and the vectors corresponding to one or more gloves 18. Controller 60 may select a glove 18 based on for example, a minimum vector distance between the vector corresponding to image 80 or 110 and the vectors corresponding to one or more gloves 18. It is contemplated that controller 60 may employ other similarity measures (e.g. vector product, covariance, etc.) to select a glove 18 from among the one or more gloves 18 for which information is retrieved from data structure 56. In some exemplary embodiments, controller 60 may determine that product characteristics of one or more gloves 18 in data structure 56 match size characteristics of hand 82 by comparing the determined degree of similarity to a predetermined similarity threshold. Thus, for example, controller 60 may select one or more gloves 18 having a degree of similarity greater than or about equal to a threshold degree of similarity. Additionally or alternatively, controller 60 may rank the one or more gloves 18 based on the determined degrees of similarity. Controller 60 may then select one or more gloves 18 having a rank higher than a predetermined threshold rank. In one exemplary embodiment, upon selecting the one or more gloves 18, controller 60 may display a size (e.g. small, medium, large, etc.) associated with each of the one or more selected gloves 18 on display 36. Additionally or alternatively, controller 60 may display images associated with the one or more selected gloves 18 on display 36.

As discussed above, in yet another exemplary embodiment, size characteristics may include palm width and finger length. Palm width, for example, may be a maximum distance across palm 96 of hand 82 as measured along a direction generally perpendicular to at least one finger of hand 82. In other exemplary embodiments, palm width may be a distance across palm 96 adjacent to a location where fingers of hand 82 may connect to palm 96. It is contemplated that the terms generally and about should be interpreted to encompass dimensions that may lie within commonly known machining or manufacturing tolerances. For example, the phrase “generally perpendicular” should be interpreted to include angles that lie in the range 90°±5°. In one exemplary embodiment, controller 60 may be configured to determine a palm width “W” as a distance between, for example, points 114 and 116 located on edges of palm 96 or between points 88 and 94 associated with the outermost fingers of hand 82. Finger length may be determined as a distance between a point located on palm 96 and a tip of a finger of hand 82. In one exemplary embodiment, controller 60 may be configured to determine a finger length “L” of, for example, middle finger 102 as a distance between points 104 and 106 located at a tip of middle finger 102. It is contemplated, however, that in other exemplary embodiments, point 104 may be located on palm 96 adjacent a wrist, or adjacent a location where finger 102 is attached to palm 96 and finger length L may be determined relative to that position of point 104.

Controller 60 may be configured to retrieve information regarding glove palm width and glove finger length for one or more gloves 18 from data structure 56. Controller 60 may also be configured to select one or more gloves 18 that have a glove palm width matching width W, and/or a glove finger length matching length L. Controller 60 may determine a match by determining the differences in the width W and/or length L obtained from image 80 or 110 and the corresponding glove palm width and/or glove palm length, respectively, for one or more of gloves 18. Controller 60 may select gloves 18 for which the difference between glove palm width and W, and/or difference between glove finger length and L fall below respective predetermined thresholds. In one exemplary embodiment, when controller 60 identifies more than one glove 18 having a glove palm width and/or glove palm length matching width W and/or length L, respectively, controller 60 may select a glove 18 that has a glove palm width that matches palm width W but has a glove finger length that may be greater than or equal to finger length L. In other exemplary embodiments, controller 60 may select all the identified gloves 18. Additionally or alternatively, controller 60 may display an image associated with the one or more selected gloves 18 on display 36. Further, when controller 60 selects more than one glove 18, controller 60 may display images associated with the plurality of selected gloves 18 simultaneously or sequentially on display 36.

It is also contemplated that in some exemplary embodiments, controller 60 may receive a selection of a one of the gloves 18 displayed on display 36 via, for example, one or more input devices 68 and/or touchscreen display 36. In response, controller 60 may superimpose a 2D or 3D model of the selected glove 18 on image 80, 110 of hand 82, thereby displaying an augmented reality (AR) image of the user's hand wearing the selected glove 18. Controller 60 may also be configured to change an orientation and/or position of the selected glove 18 on display 36 as user 16 moves hand 82 so that glove 18 tracks movements of the user's hand and fingers. Thus, for example, controller 60 may be configured to allow user 16 to visually see how the selected glove 18 may fit on hand 82. Although only two dimensions W and L are discussed above, it is contemplated that controller 60 may be configured to select one or more gloves 18 based on any combination of a plurality of dimensions that may be derived based on points 84 in images 80, 110.

It is also contemplated that in some exemplary embodiments, controller 60 may be configured to execute edge detection, pattern or shape detection, segmentation, or other image processing algorithms to detect the shape of hand 82 in image 80 or 110. Controller 60 may also be configured to determine one or more size characteristics of hand 82 based on these image processing algorithms. It is further contemplated that controller 60 may be configured to execute semantic segmentation for determining the one or more dimensions or size characteristics of hand 82. For example, controller 60 may be configured to assign a probability to every pixel in images 80, 110, the probability indicating whether or not the pixel is part of hand 82, generating an image in which pixels determined to be a part of hand 82 are identified. Controller 60 may compare this image to images retrieved, for example, from data structure 56. When a matching image is obtained, controller 60 may be configured to determine the one or more size characteristics or distances for hand 82 using information associated with the matching image. Controller 60 may select one or more gloves 18, by comparing the one or more size characteristics of hand 82 with the one or more product characteristics of products 18 using the data stored in data structure 56, using processes similar to those discussed above.

In one exemplary embodiment, platform 32 of kiosk 10 may be equipped with a grid of emitters and imaging device 40 may be equipped with one or more receivers configured to receive electromagnetic radiation (e.g. light) emitted by the optical emitters. Controller 60 may be configured to detect an outline of hand 82 based on the emitters that may be covered by hand 82, thereby blocking the electromagnetic radiation from those emitters from being received by imaging device 40. Controller 60 may also be configured to determine the scaling factor based on the known dimensions of the emitter grid and/or spacing between adjacent emitters. Controller 60 may determine one or more size characteristics of hand 82 based on the scaling factor and the detected outline of hand 82. For example, controller 60 may be configured to perform image segmentation, pattern matching, or other image processing algorithms to determine the one or more size characteristics of hand 82 based on the detected outline of hand 82. Controller 60 may select one or more gloves 18, by comparing the one or more size characteristics of hand 82 with the one or more product characteristics of products 18 using the data stored in data structure 56, using processes similar to those discussed above. Although controller 60 has been described above as determining the glove size based on a comparison of the one or more size characteristics of hand 82 with one or more product characteristics obtained from data structure 56, it is contemplated that in some exemplary embodiments, the trained machine learning model may be configured to directly generate a recommended glove size without the need for such comparisons. In such exemplary embodiments, system 50 may not include data structure 56.

It is contemplated that in some exemplary embodiments, kiosk 10 may be used for customizing one or more products purchased by or in possession of user 16. For example, in these exemplary embodiments, user 16 may present a business card or letterhead for imaging instead of placing hand 82 before imaging device 40. Imaging device 40 may obtain a digital image (80, 110) of the business card or letterhead. Controller 60 may be configured to identify a logo or other pattern from digital image 80, 110 of the business card or letterhead. Controller 60 may use processes similar to those discussed above for detecting hand 82, including, for example, using one or more trained machine learning models, to detect the logo or pattern in the business card or letterhead. Controller 60 may transmit the logo or pattern via, for example, network 52 to an engraving, etching, or printing apparatus. Controller 60 may also provide instructions via, for example, display 36 to user 16 to provide the one or more products to the engraving, etching, or printing apparatus for placing the logo or pattern on the one or more products, thereby allowing user 16 to customize the one or more products.

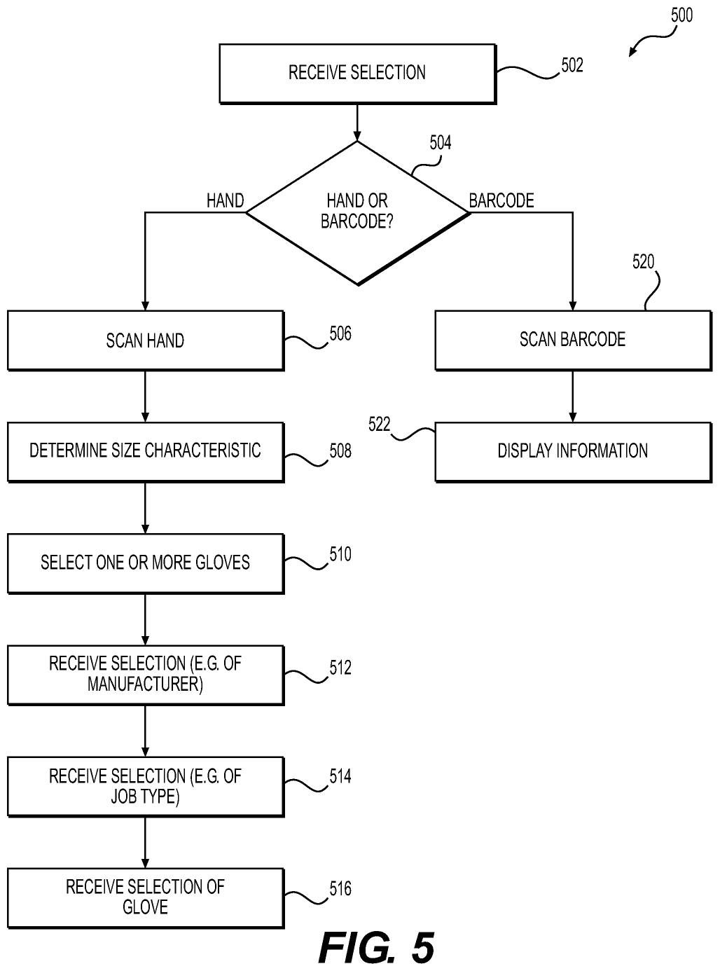

FIG. 5 illustrates an exemplary method 500 that may be performed by controller 60. For example, controller 60 of kiosk 10 and/or server 54 may perform method 500 to determine a size of hand 82 of user 16 and recommend one or more gloves 18 that may provide a best fit for hand 82. Controller 60 may also perform method 500 to provide information regarding one or more gloves 18 based on information stored in data structure 56. It is further contemplated that in some exemplary embodiments, some or all steps of method 500 may be performed by a combination of controllers 60 associated with kiosk 10, server 54, and/or user device 58. The order and arrangement of steps of method 500 is provided for purposes of illustration. As will be appreciated from this disclosure, modifications may be made to method 500 by, for example, adding, combining, removing, and/or rearranging the steps of method 500. Method 500 may be executed by controller 60 together with various other components of system 50, for example, imaging device 40, barcode scanner 42, micro projector 44, input device 68, display 36, server 54, data structure 56, etc.

Method 500 may include a step of receiving a selection from user 16 (Step 502). In operation, user 16 (e.g. customer or store associate) may initiate an interaction with kiosk 10 by, for example, pressing a “start” button displayed on, for example, a touchscreen display 36, or by touching the touchscreen display 36. Display 36 may send a signal to controller 60 indicating pressing of the “start” button or detection of a touch on display 36. In response, controller 60 may provide additional instructions to user 16 via display 36. Controller 60 may cause display 36 to display one or more graphical icons or widgets that may be activated by user 16 via touchscreen display 36 and/or input device 68 to make the selection. For example, controller 60 may display icons on display 36, with a first icon inviting user 16 to scan a barcode and a second icon inviting user 16 to scan the user's hand to determine hand size. Controller 60 may monitor touchscreen display 36 and/or input device 68 to receive a signal indicating the user selection.

It is also contemplated that in some exemplary embodiments, controller 60 may monitor signals from imaging device 40 to detect whether user 16 has placed hand 82 for imaging. In these embodiments, controller 60 may directly proceed to step 508 of method 500. Similarly, controller 60 may monitor signals from imaging device 40 and/or barcode scanner 42 to detect whether user 16 has placed a barcode before imaging device 40 and/or barcode scanner 42. When controller 60 determines that a barcode has been placed before imaging device 40 and/or barcode scanner 42, controller 60 may directly proceed to step 520 of method 500.

Method 500 may include a step of determining whether the user has elected to scan the user's hand or barcode (Step 504). When controller 60 determines that the user has selected scanning the user's hand (Step 504: Hand), controller 60 may proceed to step 506. When controller 60 determines, however, that the user has elected to scan a barcode (Step 504: Barcode), controller 60 may proceed to step 520.

In step 506, controller 60 may provide instructions to user 16 via display 36 to place hand 82 on platform 32 of kiosk 10 or to place hand 82 in front of imaging device 40 when kiosk 10 does not include platform 32. Controller 60 may monitor signals received from imaging device 40 to determine whether user 16 has placed his or her hand 82 on platform 32 or in front of imaging device 40. When controller 60 determines that hand 82 has been placed on platform 32 and/or in front of imaging device 40, controller 60 may control or activate imaging device 40 and/or micro projector 44 to scan hand 82 to obtain digital image 80 or 110 of hand 82. As discussed above, controller 60 may superimpose a plurality of points 84 in image 80 or 110.

Method 500 may include a step of determining one or more size characteristics of hand 82 (Step 508). Controller 60 may perform one or more processes discussed above to determine the one or more size characteristics of hand 82. For example, controller 60 may determine distances between points 84, and/or determine a width W of palm 96 and a length L of middle finger 102, etc. In some exemplary embodiments, controller 60 may classify a size of hand 82 as being one of small, medium, large, extra-large, etc. based on the determined one or more size characteristics, and display the determined size on display 36.

Method 500 may include a step of selecting one or more gloves 18 (Step 510). Controller 60 may perform one or more processes discussed above of comparing the one or more size characteristics of hand 82 determined, for example, in step 508 with one or more product characteristics retrieved from data structure 56. Controller 60 may select one or more gloves 18 based on the comparison, using processes similar to those discussed above. For example, controller 60 may select one or more gloves 18 having a glove palm width or glove finger length matching a palm width W or finger length L of hand 82, respectively. By way of another example, controller 60 may select one or more gloves 18 based on determining a similarity metric between a vector associated with hand 82 and vectors corresponding to one or more gloves 18 retrieved from data structure 56. Controller 60 may determine a size (e.g. small, medium, large, etc.) associated with the one or more selected gloves 18.

Controller 60 may display the determined sizes and/or images associated with the one or more selected gloves 18 on display 36. In one exemplar embodiment, controller 60 may display a first set of selected gloves 18, for example, from different manufacturers, or being made of different materials on display 36. Controller 60 may also cause display 36 to display one or more graphical icons or widgets corresponding to the different manufacturers, brands, or materials. The one or more graphical icons or widgets may be activatable by user 16 via touchscreen display 36 and/or input device 68 to make a selection.

Method 500 may include a step of receiving selection (e.g. of a manufacturer) via an icon or widget displayed on display 36 (Step 512). For example, controller 60 may monitor touchscreen display 36 and/or input device 38 to determine whether user 16 has made a selection of an icon/widget, for example, corresponding to a particular manufacturer or brand. In response to receiving a selection, controller 60 may select a second set of gloves from the first set of gloves, corresponding to the selected manufacturer or brand. As discussed above, product characteristics stored in data structure 56 may include information such as manufacturer, brand, color, price, etc. for each product stored in data structure 56. Controller may display sizes or images of the one or more gloves 18 included in the second set of gloves on display 36. In some exemplary embodiments, controller 60 may cause display 36 to display additional icons or widgets corresponding to, for example, different applications or job types (e.g. construction, landscaping, gardening, automotive, etc.).

Method 500 may include a step of receiving a selection (e.g. of a job type) via an icon or widget displayed on display 36 (Step 514). For example, controller 60 may monitor touchscreen display 36 and/or input device 38 to determine whether user 16 has made a selection of an icon/widget, for example, corresponding to a particular job type. In response to receiving a selection, controller 60 may select a third set of gloves from the second set of gloves, corresponding to the selected job type. Controller may display sizes or images of the one or more gloves 18 included in the third set of gloves on display 36.

Method 500 may include a step of receiving a selection of glove 18 from the third set of gloves (Step 516). For example, controller 60 may monitor touchscreen display 36 and/or input device 38 to determine whether user 16 has made a selection of an icon, widget, or image, for example, corresponding to a particular glove 18 displayed on display 36. In response to receiving a selection, controller 60 may display additional information for the selected glove 18 on display 36. Such information may include, for example, promotional or marketing material, care instructions, pricing, availability in retail location 12, etc., associated with selected glove 18. It is contemplated that controller 60 may monitor touchscreen display 36 and/or input device 38 to determine whether user 16 has made a selection of an icon, widget, or image, for example, corresponding to a particular glove 18 from the first set of gloves in step 510 or the second set of gloves in step 512. It is further contemplated that controller 60 may perform processes similar to those discussed for step 516 when a particular glove 18 is selected in steps 510 or 512. It is also contemplated that in some exemplary embodiments, in one or more of steps 510, 512, and/or 514, instead of displaying images of the one or more gloves 18 on display 36, controller 60 may display a website or portal associated with the one or more manufacturers or sellers of the one or more selected gloves 18 on display 36. In such embodiments, user 16 may then be able to interact with kiosk 10 using the one or more input devices 68 and/or touchscreen display 36 to view and/or order one or more of the selected gloves 18 directly from the manufacturer's or sellers website or portal.

Returning to step 504, when controller 60 determines that the user has elected to scan a barcode (Step 504: Barcode), controller 60 may proceed to step 520 of scanning a barcode. In step 520, controller 60 may provide additional instructions to the user via display 36. For example, controller may invite user 16 to place glove 18 with its barcode facing platform 34 or barcode scanner 42. Controller 60 may monitor signals received from barcode scanner 42 to determine whether user 16 has placed glove 18 on platform 32. When controller 60 determines that glove 18 has been placed on platform 32, controller 60 may control or activate barcode scanner 42 to scan the barcode associated with glove 18. It is contemplated, however, that in some exemplary embodiment, instead of reading a barcode, imaging device 40 may be configured to obtain an image of glove 18 presented by user 16. Controller 60 may then use a trained machine learning model to identify the product in the image without the need for reading a barcode.

Method 500 may include a step of displaying information associated with glove 18 on display 36 (Step 522). Controller 60 may use the information stored in the barcode to retrieve additional information about glove 18 from data structure 56. Controller 60 may display the additional information on display 36. Such information may include, for example, promotional or marketing material, care instructions, pricing, availability in retail location 12, etc., associated with glove 18 corresponding to the information stored in the barcode. Alternatively, controller 60 may display the additional information based on identification of the product, by the machine learning model, without the need to retrieve the additional information from data structure 56.

Method 500 may make it possible for user 16 to select a glove 18 that provides a best fit for hand 82 of user 16, without the need for any additional equipment (e.g. tape measure or ruler) and without the assistance of, for example, a store associate. Furthermore, kiosk 10, system 50, and method 500 may make it convenient for user 16 to find glove 18 without the need to try gloves of different sizes from different manufacturers to determine the best fit size for each manufacturer.

Although method 500 has been described above using gloves 18 as an example, it is contemplated that some or all steps of method 500 together with kiosk 10 and system 50 may be useable to conveniently determine sizes of other products, for example, rings, bracelets, watch straps, shoes, etc. For example, instead of using palm width W and finger length L, controller 60 may be configured to determine a width “W₁” of a ring finger (see FIG. 4A), or width “W₂” of a wrist (see FIG. 4A) associated with hand 82 based on digital image 80 or 110 and points 84. For example, controller 60 may be configured to superimpose points 84 on opposite edges of the fingers and/or wrist associated with hand 82 in digital images 80 or 110. Furthermore, data structure 56 may be configured to store information regarding one or more rings, one or more bracelets, one or more watch straps, etc. together with the diameters of the rings and bracelets, and/or lengths of the watch straps. Controller 60 may be configured to identify rings, bracelets, and/or watch straps corresponding to widths W₁ and/or W₂ using processes similar to those discussed above for selection of gloves 18. It is, therefore, contemplated that kiosk 10, system 50, and/or method 500 may additionally or alternatively be configured to determine a best fit size of a ring, a bracelet, a watch strap etc. based on digital images 80 or 110.

In a similar manner, for example, imaging device 40 of kiosk 10 may be configured to obtain digital images 80, 110 of a foot of user 16, which may be placed on platform 32 or below imaging device 40 in kiosks 10 that do not include platform 32. Controller 60 may be configured to determine one or more size characteristics associated with the foot. Controller 60 may also be configured to retrieve one or more product characteristics associated with one or more shoes from data structure 56. Controller 60 may be configured to executed one or more processes similar to those discussed above to identify one or more shoes that may have one or more product characteristics matching one or more size characteristics of the foot of user 16. It is also contemplated that in some exemplary embodiments, controller 60 may use a trained machine learning model to determine the size characteristics and/or to directly identify a best fit shoe size for user 16, using one or more processes discussed above.

It is further contemplated that in some exemplary embodiments, user 16 may obtain an image of hand 82 using user device 58. For example, user 16 may be able to obtain a digital image using a camera associated with a mobile phone. User device 58 may be configured to send the digital image with or without the superimposed points 84 to kiosk 10 and/or server 54. Controller 60 of kiosk 10 and/or server 54 may perform one or more steps 508-518 using the image received from user device 58 to identify and display a product (e.g. glove 18) having a best fit size for user 16 either on display 36 associated with kiosk 10, or on a display associated with user device 58. It is also contemplated that in some exemplary embodiments, controller 60 of kiosk 10 and/or server 54 may be configured to display the one or more icons/widgets discussed above in, for example, steps 502-520 of method 500 on user device 58. Controller 60 of kiosk 10 and/or server 54 may also be configured to receive user selections made on user device 58 via communications interface 66. Thus, kiosk 10, server 54, and user device 58 may interact with each other to allow the user to perform method 500 on user device 58 without touching or accessing kiosk 10 and/or without going to retail location 12.

It will be apparent to those skilled in the art that various modifications and variations can be made to the disclosed kiosk for determining glove size. Other embodiments will be apparent to those skilled in the art from consideration of the specification and practice of the disclosed kiosk for determining glove size. It is intended that the specification and examples be considered as exemplary only, with a true scope being indicated by the following claims and their equivalents.

What is claimed is:

1. A self-service kiosk, comprising:
a platform configured for placement of a user's hand;
an imaging device configured to acquire at least one of a digital image or a scan of the hand;
at least one memory;
at least one processor configured to execute instructions stored in the at least one memory to:
determine at least one size characteristic of the hand based on the digital image or the scan;
compare the at least one size characteristic with one or more product characteristics stored in a data structure, the one or more product characteristics being associated with one or more products; and
select at least one product from the one or more products, the at least one product including at least one product characteristic matching the at least one size characteristic; and
a display configured to display information associated with the at least one product selected by the at least one processor.

2. The self-service kiosk of claim 1, wherein the at least one product includes a glove.

3. The self-service kiosk of claim 2, wherein the information associated with the glove includes at least one of a size of the glove or an image of the glove.

4. The self-service kiosk of claim 2, wherein the at least one size characteristic includes a first dimension associated with the hand and a second dimension associated with the hand.

5. The self-service kiosk of claim 4 wherein the processor is configured to select the glove based on at least one of the first dimension and the second dimension.

6. The self-service kiosk of claim 5, wherein
the first dimension is a width of a palm of the hand; and
the second dimension is a length of a finger of the hand.

7. The self-service kiosk of claim 6, wherein the finger is a middle finger of the hand.

8. The self-service kiosk of claim 6, wherein the length of the finger is determined as a distance between a center of the palm and a tip of the finger.

9. The self-service kiosk of claim 6, wherein the processor is configured to:
receive, from the data structure, the information associated with a plurality of gloves, the information including a glove palm width and a glove finger length for each of the gloves;
select, from the data structure, a first set of gloves, each of the first set of gloves having at least one of the glove palm width or the glove finger length being about equal to a respective one of the width of the palm or the length of the finger; and
select the glove from the first set of gloves.

10. The self-service kiosk of claim 9, wherein the processor is configured to select the glove by:
selecting from the data structure the first set of gloves, each of the first set of gloves having the glove palm width being about equal to the width of the palm
determining a first finger length associated with a first glove in the first set of gloves;
determining a second finger length associated with a second glove in the first set of gloves;
selecting the first glove as the glove when the first finger length is greater than the second finger length.

11. The self-service kiosk of claim 4, wherein the processor is configured to determine the first dimension and the second dimension using a machine learning model.

12. The self-service kiosk of claim 11, wherein an off-board processor is configured to train the machine learning model by:
receiving a training set including a plurality of images, each image of the plurality of images including an image of a hand;
receiving inputs specifying one or more size characteristics of the hand in the each image; and
training the machine learning model based on the plurality of images and the received inputs.

13. The self-service kiosk of claim 12, wherein receiving the inputs includes:
receiving inputs identifying a plurality of locations on the hand in the each image;
receiving a scaling factor; and
determining the at least one size characteristic based on the received locations and the scaling factor.

14. The self-service kiosk of claim 12, wherein the processor is further configured to:
superimpose a plurality of points on the digital image or the scan of the hand based on the machine learning model;
determine distances between at least some of the points; and
determine the first dimension and the second dimension based on the determined distances.

15. The self-service kiosk of claim 14, wherein the processor is further configured to:
generate a vector for the hand, the vector including the determined distances;
retrieve, from the data structure, a plurality of vectors associated with a plurality of gloves, each of the retrieved vectors including distances between locations on a respective one of the gloves;
determine a degree of similarity between the vector for the hand and each of the vectors associated with the gloves; and
select at least one glove based on the determined degree of similarity.

16. A self-service kiosk for determining hand size, comprising:
a platform configured for placement of a user's hand;
a camera configured to acquire a digital image of the hand;
at least one memory;
at least one processor configured to execute instructions stored in the at least one memory to:
determine a palm width and a finger length of the hand based on the digital image;
receive, from a data structure, information including a plurality of glove palm widths and glove finger lengths corresponding to a plurality of gloves;
compare the palm width and the finger length of the hand with the information received from the data structure;
select at least one glove from the plurality of gloves, the at least one glove having at least one of a glove palm width or a glove finger length matching a respective one of the palm width or the finger length of the hand; and
determine a size of the at least one glove based on the information received from the data structure; and
a display configured to display the determined size of the at least one glove.

17. The self-service kiosk of claim 16, wherein the processor is configured to execute a machine learning model to superimpose a plurality of points on the digital image, the points including:
a first point disposed adjacent to a first edge of a palm of the hand;
a second point disposed adjacent to an opposite edge of the palm;
a third point disposed adjacent to a geometric center of the palm; and
a fourth point disposed adjacent to a tip of a middle finger of the hand.

18. The self-service kiosk of claim 17, wherein the processor is configured to:
determine the palm width as a distance between the first and second points; and
determine the finger length as a distance between the third and fourth points.

19. The self-service kiosk of claim 18, wherein the processor is configured to:
select a first set of gloves from the plurality of gloves, each glove in the first set of gloves having at least one of the glove palm width or the glove finger length matching a respective one of the palm width or the finger length determined from the digital image;
receive a first input indicating a selection of one of a manufacturer or a brand;
select a second set of gloves from the first set of gloves based on the first input, the second set of gloves being associated with the selected manufacturer or the selected brand; and
display sizes or images associated with the second set of gloves on the display.

20. The self-service kiosk of claim 19, wherein the processor is further configured to:
receive a second input indicating a selection of a job type;
select a third set of gloves from the second set of gloves based on the second input, the third set of gloves being associated with the selected job type; and
display sizes or images associated with the third set of gloves on the display.
